(19) United States
(12) Patent Application Publication
(10) Pub. No.: US 2025/0189816 A1
(43) Pub. Date: Jun. 12, 2025

(54) HEAD-MOUNTABLE ELECTRONIC DEVICE

(71) Applicant: Apple Inc., Cupertino, CA (US)

(72) Inventors: Alison B. Shutzberg, San Francisco, CA (US); Ethan L. Huwe, Woodinville, WA (US); John Raff, Menlo Park, CA (US)

(21) Appl. No.: 18/845,574

(22) PCT Filed: Mar. 28, 2023
(86) PCT No.: PCT/US2023/016618

§ 371 Date: Sep. 10, 2024

Related U.S. Application Data
(60) Provisional application No. 63/362,310, filed on Mar. 31, 2022.

(51) Int. Cl. G02C 5/14; G02B 27/01; G02C 11/00

(52) U.S. Cl. CPC G02C 5/14; G02B 27/0176; G02C 11/10; G02B 2027/0178; G02C 2200/02

(57) ABSTRACT

A securement arm of an optical device can include a first portion and a second portion. The first portion can include a first housing defining a first internal volume and a first aperture and an electronic component disposed in the internal volume and positioned to fluidly communicate with an external environment through the first aperture. The second portion can be removably connected to the first portion and include a second housing defining a second internal volume and a second aperture and a securement mechanism. The second housing can receive the first housing into the second internal volume.

### CROSS-REFERENCE TO RELATED APPLICATION(S)

This application is a national stage filing based off of PCT Application No. PCT/US2023/016618, filed Mar. 28, 2023, entitled “HEAD-MOUNTABLE ELECTRONIC DEVICE” and claims priority to U.S. Provisional Patent Application No. 63/362,310, filed 31 Mar. 2022, entitled “HEAD-MOUNTABLE ELECTRONIC DEVICE,” the entire disclosures of which are hereby incorporated by reference.

### FIELD

The described embodiments relate generally to electronic devices. More particularly, the present disclosure relates to head-mountable electronic devices.

### BACKGROUND

Recent advances in portable computing have enabled head-mountable devices that provide augmented and virtual reality experiences to users. Various component of these devices, such as display screens, viewing frames, securement arms, speakers, batteries, and other components, operate together to provide an immersive and comfortable experience. However, the anatomy of each user's head is unique. One user's head can be larger than another or one head can be a different shape. Other anatomical features, including relative positions of a user's nose, forehead, and ears, can vary widely between users as well. The anatomical variety of heads presents a challenge for head-mountable devices designed for comfort and reliability.

In some head-mountable devices, for example, securement arms that extend along, or make contact with, opposing sides of a user's head can be used to secure the device to the user's head. However, the dimensions, angles, shape, and other physical characteristics of the arms that may be sufficient to comfortably and reliably secure the device to one user's head may not be sufficient to comfortably and reliably secure the device to another user's head.

Additionally, head-mountable devices can be used in a variety of different settings and during a variety of different activities. These can range from lying down still in bed to mountain biking or hiking outdoors. Thus, even for a single user, the securement arms of a head-mountable device that are comfortable and sufficient for securing the device during one activity may not be comfortable or sufficient for another activity.

Furthermore, head-mountable devices, as noted above, can include a number of electronic components configured to operate together to produce an altered or virtual reality experience to the user. Users often desire light weight, compact devices that are comfortable, portable, long lasting, and easily handled. Thus, the physical configuration of these electronic components, including batteries, speakers, processors, and so forth, affects the quality of the user's experience.

Accordingly, what is needed in the art are head-mountable devices and systems providing users having a wide variety of anatomical features and who participate in a wide variety of activities with comfortable and reliable components.

### SUMMARY

In at least one example of the present disclosure, a removable securement arm of an optical device can include a housing defining an internal volume having an open proximal cavity, an electronic component disposed in the internal volume distal to the open proximal cavity, and an electrical connector disposed on the housing.

In one example, the electronic component can include a battery. In one example, the electronic component can be disposed in a distal portion defined by the housing. In one example, the electrical connector can be disposed at a proximal end of the housing. In one example, the removable securement arm can include a circuitry component connecting the electrical connector to the electrical component. In one example, a proximal end of the removable securement arm is open. In one example, the housing defines an aperture distal to the open proximal end.

In at least one example of the present disclosure, a securement arm of an optical device can include a first portion and a second portion. The first portion can include a first housing defining a first internal volume and a first aperture and an electronic component disposed in the internal volume and positioned to fluidly communicate with an external environment through the first aperture. The second portion can be removably connected to the first portion and include a second housing defining a second internal volume and a second aperture and a securement mechanism. In such an example, the second housing can receive the first housing into the second internal volume.

In one example, the securement mechanism can include a magnet. In one example, the electronic component can include a speaker. In one example, the magnet actuates the speaker. In one example, the speaker can direct sound out of the second aperture. In one example, a gap is formed between an external surface of the first housing and an internal surface of the second housing.

In at least one example of the present disclosure, a head-mountable display can include a viewing frame, a first arm portion, and a second arm portion removably secured to the first arm portion. The first arm portion can include a first housing extending from a proximal end to a distal end. The second arm portion can include a second housing defining a second internal volume having an open cavity. In such an example, the second arm portion contacts the first arm portion at the proximal end and the first housing is free-floating in the open cavity.

In one example, the first housing defines a first internal volume and a first electronic component is disposed in the first internal volume. In one example, the head-mountable display can further include a second electronic component disposed in the second internal volume. In one example, the second electronic component can include a battery. In one example, the first electronic component can include a speaker. In one example, the second arm portion can include a magnet. In one example, the magnet actuates the speaker.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a top view of an example of a head-mountable electronic device worn by a user;

FIG. 2A shows a top view of an example of a head-mountable electronic device worn by a user;

FIG. 2B shows a top view of an example of a head-mountable electronic device worn by a user;

FIG. 3 shows a side view of an example of a removable securement arm;

FIG. 4 shows a side view of an example of a head-mountable electronic device with a removable securement arm;

FIG. 5 shows a side view of an example of a head-mountable electronic device with a removable securement arm;

FIG. 6 shows a side view of an example of a head-mountable electronic device with a removable securement arm;

FIG. 7 shows a partial cross-sectional view of an example of a securement arm of a head-mountable electronic device;

FIG. 8 shows a side view of an example of a head-mountable electronic device with a removable securement arm;

FIG. 9 shows a partial cross-sectional view of an example of a securement arm of a head-mountable electronic device;

FIG. 10A shows a partial cross-sectional view of an example of a securement arm of a head-mountable electronic device; and

FIG. 10B shows a cross-sectional view thereof.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to electronic devices. More particularly, the present disclosure relates to head-mountable electronic devices. In at least one example, a head-mountable device can include a viewing frame and a securement arm extending from the viewing frame. Examples of head-mountable electronic devices can include virtual reality or augmented reality devices that include an optical component. In the case of augmented reality devices, optical eyeglasses can be worn on the head of a user such that optical lenses and/or optical displays are positioned in front of the user's eyes. In another example, a virtual reality device can be worn on the head of a user such that a display screen is positioned in front of the user's eyes. The viewing frame can include a housing or other structural component supporting or housing the optical component, for example lenses or screens.

Examples of the present disclosure can include a securement arm extending from the viewing frame, which can be fixed in position relative to the viewing frame or rotatably secured thereto. An optical electronic device can include two opposing securement arms that can apply pressure to or around a user's head to maintain the viewing frame resting on the user's nose and/or cheeks. In some examples, the securement arms can rest on top of the user's ears to assist in securing the head-mountable optical device to the head of the user.

The securement arm can include multiple portions and one or more electronic components used to operate the head-mountable electronic device. These electronic components can include any components used by the head-mountable electronic device to produce a virtual or augmented reality experience. For example, electronic components of the securement arm can include one or more speakers, processors, batteries, circuitry components including wires and circuit boards, or any other electronic components used in the head-mountable device to deliver augmented or virtual reality visuals, sounds, and other outputs. Disposing various electronic components within the securement arm reduces weight and space needed for the viewing frame and lenses and/or display screens of the device. This redistributed weight can relieve pressure of sensitive features like the user's nose and cheeks to create a more comfortable experience. This weight distribution can also be used to balance weight from the front of the device (at the viewing frame) to the back of the device (at the distal ends of the securement arms), resulting in a more secure and comfortable experience.

In examples where the securement arm includes multiple portions, a first arm portion can extend from the viewing frame and include a first housing extending from a proximal end to a distal end. A second portion of the arm can be removably secured to the first arm portion, with the second arm portion including a second housing defining a second internal volume having an open cavity. In such examples, various electronic components can be disposed in the first and second housings of the arm portions and be electrically connected when the first and second portions are secured together. The second portion having the open cavity can include an electrical connector that completes an electrical circuit to electrically connect the electronic components disposed in the first and second portions.

For example, the a battery can be disposed in the second portion so that when the first portion and the second portion are connected, the battery delivers power to electronic components of the first portion and/or components in the viewing frame, such as display components. The first portion of the securement arm can include any number of components powered by the battery of the second portion of the securement arm, including processors, speakers, logic boards and other circuit elements, sensors, and so forth.

Head-mountable electronic devices, such as head-mountable optical devices delivering virtual and augmented reality experiences, can be used in a variety of different settings and during a variety of activities. For example, a user may lie down on a sofa or a bed while watching a movie or playing a game with a head-mountable virtual reality device. That same device, or some other augmented reality device, such as electronic glasses, can be used while exercising indoors on an exercise machine. Similarly, devices like augmented reality glasses can be used while being active outdoors, either while hiking, biking, or swimming. The devices of the present disclosure include components, such as securement arms, which can be adapted to effectively secure head-mountable devices to the user during any of the various activities in which the user participates.

In addition, the head measurements and anatomical features of each user vary such that a securement arm of the same length, shape, and curvature, may not be appropriate for every user. For example, some heads are more round than others. Some heads are larger or smaller and the position of a user's nose relative to their eyes can vary. The position of a user's ears relative to their nose or forehead can vary from one user to another such that a set of securement arms that effectively secure a head-mountable device to one user may not effectively secure the same device to anther user.

In addition, manufacturing individualized arms for each unique customer can be burdensome and often economically unfeasible. Because the second portion of securement arms disclosed herein are removable from the first portions, a user can swap out the second portion with another portion having a fully charged battery or another portion with a shape and size that better fits his or her head. In examples of the present disclosure, different portions of the securement arms of head-mountable devices can be disconnected, reconnected, and otherwise swapped out to provide customized fits and long lasting power during use. The various portions can be connected in such a way that the head-mountable display continues to function seamlessly regardless of the swappable portions and the components in the securement arms are protected from wear and tear due to constant swapping and use.

For example, a first housing of the first portion of a securement arm can extend into an open, empty cavity of the internal volume of the second portion with a gap or empty space between the outer surface of the first housing and an inner surface of the second housing of the second portion. In this way, forces and strains acting on the second portion, whether due to connecting and disconnecting the portions or due to normal use of the device, do not transfer to the first housing and the electronic components disposed therein.

As noted above, the head-mountable electronic devices of the present disclosure include securement arms and components that can be manufactured to be used with different head anatomies and during various activities. The same user can swap out a portion of the securement arms of a device, for example, to pressure more tightly or wrap further around his or her head when using the head-mountable device for exercise or other active scenarios. The same user can swap out a portion of the securement arms again for a more comfortable fit while using the head-mountable device for less active scenarios, including lying down, sitting, or walking. In addition, some head-mountable devices may be used by multiple people, including multiple people in a household or business office, with each person having a different head geometry. Securement arms for devices described herein can be swapped out for the same device to be comfortably and effectively used by each of the multiple individuals using the device.

In addition, swapping out portions of the securement arms of a head-mountable device can lengthen operation of the device. A swappable portion, for example, can include a battery that powers the device such that swapping that portion out with a portion having a fully recharged battery allows the user to continue using the device while the battery of the removed portion recharges. If the user multiple portions to swap out in this way, the device can be used without running out of power at all.

In addition to the functional advantages described herein, the securement arms of the exemplary head-mountable devices described herein can offer unique opportunities for style customization to the user. Users can opt for securement arms of different colors and materials to differentiate the electronic device and make the device more personal to the user. The designs and aesthetic appearance of the securement arms can also be easily altered to accommodate different looks and preferences.

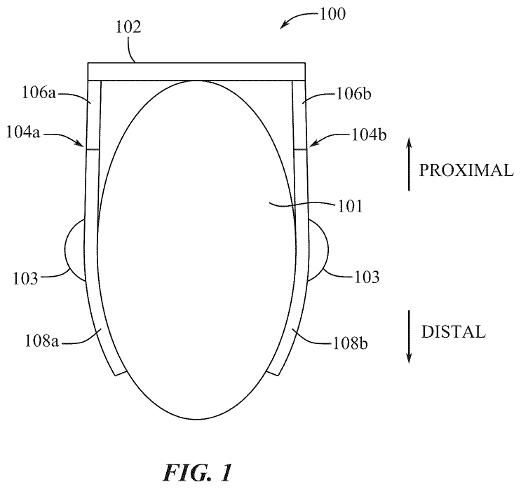

These and other embodiments are discussed below with reference to FIGS. 1-10B. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a top view of an example of a head-mountable electronic device 100 worn on the head 101 of a user. The device 100 can include a viewing frame 102 configured to secure one or more optical lenses or display screens in front of the eyes of the user. The device 100 can also include one or more securement arms 104a, 104b secured to the viewing frame 102 and extending distally toward the rear of the user's head 101. In the illustrated example, the securement arms 104a, 104b extend over the user's ears 103 and curve along with the user's head 101. The securement arms 104a, 104b can apply opposing pressures to the sides of the user's head 101, as shown, to secure the device 100 to the user's head 101. The securement arms 104a, 104b can also rest on the user's ears 103 and secure the device 100 via friction between the securement arms 104a, 104b and the head 101.

As noted, the securement arms 104a, 104b can also curve along with the curve of the user's head 101. In particular, in at least one example, the securement arms 104a, 104b can include a first proximal portion 106a, 106b and a second distal portion 108a, 108b, respectively. The terms “proximal” and “distal” can be used to reference the position of various components of devices described herein relative to the viewing frame 102 of the device 100. The orientation of the “proximal” and “distal” directions relative to devices described herein is shown in FIG. 1.

The second portion 108a, 108b of each arm 104a, 104b can be curved or disposed at an angle relative to the first proximal portion 106a, 106b such that at least a portion of each arm 104a, 104b makes contact along a length of the side of the user's head. In the illustrated example of FIG. 1, at least the second portions 108a, 108b of the arms 104a, 104b curve with the user's head 101 to make contact with the head 101. In addition, the arms 104a, 104b can extend distally and curve around a portion of the back of user's head 101, as shown, to hook around the head 101 and prevent the viewing frame 102 from being pulled forward proximally off the face/head 101 of the user.

However, as noted above, the head 101 of the user can be a unique shape and size with a unique position of each ear 103 such that the curvature of the arms 104a, 104b of the device 100 shown in FIG. 1 may not be a match for the curvature and anatomy of the head of a different user. In general, the hooked arms 104a, 104b around the sides and rear of the head 101 in addition to the increased contact area and/or length between the arms 104a, 104b and head 101 improve the resistance of the arms 104a, 104b to forces pulling the viewing frame 102 proximally off the user's head 101. Such forces can arise from jostling and bumping during normal use of the device 100 or more detrimentally during falls or contact with other objects during use. Thus, the curvature of the securement arms 104a, 104b, and more particularly the curvature of the second portions 108a, 108b of the arms 104a, 104b, which can be effective for retaining the device 100 on the head 101 shown in FIG. 1, may not be effective for a user with a head of a different size or shape.

The second portions 108a, 108b of the securement arms 104a, 104b shown in the examples of FIG. 1 can be removably secured to the first portions 106a, 106b of the securement arms 104a, 104b. In this way, if the user desires a second portion 108a, 108b having a different size or curvature to better fit his or her head, the user can remove one or both of the second portions 108a, 108b from the first portions 106a, 106b and reconnect another more suitable second portion 108a, 108b. This can also be done in order to swap out a second portion 108a, 108b if the second portion 108a, 108b includes a battery that needs recharging so that another second portion 108a, 108b with a fully charged battery can be reconnected for further use of the device 100. More details regarding the connection features, electronic components and electrical connectivity between the first and second portions 106a, 106b, 108a, 108b shown in FIG. 1 will be given in more detail in reference to other figures described below.

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1.

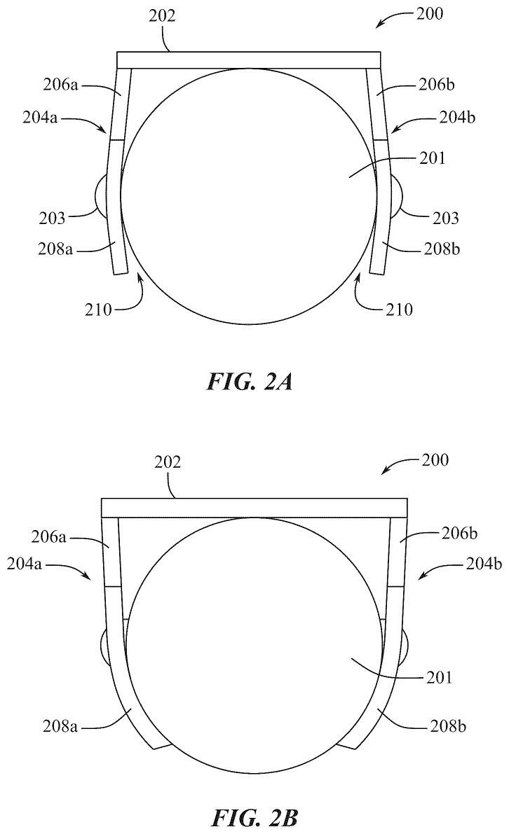

A user having a head 201 of a different size and shape as that of the head 101 shown in FIG. 1 is shown in FIG. 2. The same or similar head-mountable electronic device 200 can include a viewing frame 202 secured, at least in part, to the user's head 201 via one or more securement arms 204a, 204b. As show, the securement arms 204a, 204b can extend distally along opposing sides of the head 201 and include first portions 206a, 206b and second portions 208a, 208b removably connected to the first portions 206a, 206b. In the example shown, the arms 204a, 204b can extend over the user's ears 203 and toward the rear of the user's head 201. However, due to the shape of the user's head 201, the curvature of the arms 204a, 204b results in a gap 210 between the head 201 and the arms 204a, 204b.

In at least one example, the second portions 208a, 208b of the arms 204a, 204b can be configured to be disconnected and different second portions 208a, 208b of a different size and/or shape/curvature (shown in FIG. 2B) can be reconnected to eliminate the gap 210 and increase the contact area and/or length between the arms 204a, 204b and the head 201. The second portions 208a, 208b of the arms 204a, 204b can also be reconfigured to hook further around the user's head 201 to more effectively secure the device 200 to the head 201. As shown in FIG. 2B, the arms 204a, 204b include a second portions 208a, 208b, respectively, that can be fitted to curve with the profile and anatomical features of the user's head 201 as shown.

Any of the features, components, and/or parts, including the arrangements and configurations thereof shown in FIGS. 2A and 2B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 2A and 2B.

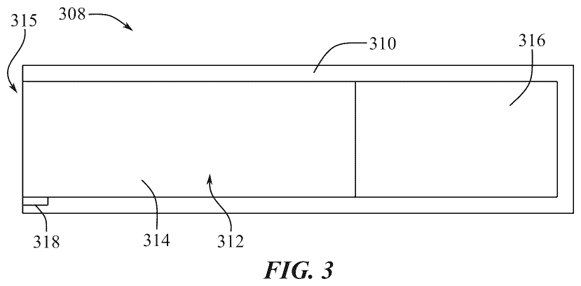

FIG. 3 illustrates a side, cross-sectional view of an example of a second portion 308 of a securement arm. As used herein, the term “removable arm” can refer to a removable portion of a securement arm, similar to the second portions 108a, 108b, 208a, 208b shown in FIGS. 1-2B. That is, as shown in FIG. 3, the second portion 308 shown by itself can simply be referred to as a removable securement arm, removable arm, and so forth, indicating that the removable arm 308 shown can be configured to be removably connected to a first portion or non-removable portion of a securement arm connected to the viewing frame of a head-mountable display, such as those shown in FIGS. 1-2B and elsewhere throughout this specification. The first portion to which the removable arm 308 is configured to connect and disconnect can be permanently or fixedly connected to the viewing frame of a device such that the removable arms 308 described herein are removable from the fixed portion of the securement arm.

However, one or more other examples can also include first portions that are removably connected to the viewing frame or other components of the device. In any case, the removable arms referred to herein are configured to be removably connected to the first portions 106a, 106b, 206a, 206b shown in FIGS. 1-2B. In some examples, the removable portions 308 described herein can be configured to be removably connected directly to the viewing frame or other component of a head-mountable device rather than directly to some other portion of a securement arm of the device. In such examples, the removable portion 308 can be configured to be electrically connected to the other portion of the securement arm, either through the viewing frame or some other component of the device.

In the illustrated example of FIG. 3, the removable arm 308 of an optical device can include a housing 310 defining an internal volume 312 and an open proximal cavity 314, an electronic component 316 disposed in the internal volume adjacent to the open proximal cavity 314, and an electrical connector 318 disposed on the housing 310. In one example, the electronic component 316 is disposed distal to the open proximal cavity 314. In at least one example, an opening 315 is defined by a proximal end of the housing 310, providing access to the open cavity 314 of the internal volume 310. In at least one example, the electronic component 316 can include one or more batteries and be disposed in a distal portion of the internal volume 312 defined by the housing 310.

In addition, at least one example of the removable arm 308 can also include an electrical connector 318 disposed at a proximal end of the housing 310. The electrical connector can be electrically connected to the electronic component 316 and provide an electrical contact with another portion of a securement arm, or other component of the head-mountable device to which the removable arm 308 can be connected, in order to complete an electrical circuit between the electronic component(s) 316 of the removable arm 308 and any electronic components of the device or other arm portion to which the removable arm 308 is connected. In at least one example, the electrical connector 318 can be disposed at a proximal end of the housing 310, as shown in FIG. 3. Other examples can include electrical connectors 318 disposed elsewhere on the housing, including at a distal end or portion of the housing 310 or on an outer or end surface of the housing 310.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3.

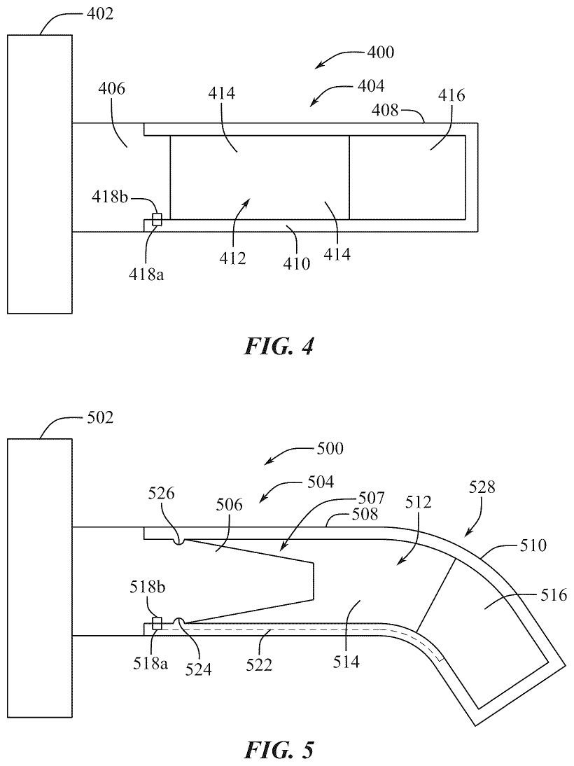

FIG. 4 illustrates an example of a head-mountable electronic device 400, such as a virtual reality or augmented reality optical device. The device 400 can include a viewing frame 402 and a securement arm 404 extending from the viewing frame 402. In at least one example, the securement arm 404 can include a first portion 406 and a second portion 408 removably connected to the first portion 406. In the illustrated example, the second portion 408 is positioned generally distally to the first portion 406. The second portion can include a housing 410 defining an internal volume 412 that has an open cavity 414. The second portion 408 can also include an electronic component 416 disposed distally to the open cavity 414 in the internal volume 412, as shown. Disposing the electronic component 416 distally in the second portion 408 can increase weight at the distal end of the device 400 to balance the weight of the display frame 402, which may include other electronic components, lenses, and displays. This can provide a more balanced and comfortable fit for the user.

The first portion 406 can include an electrical connector 418b that contacts an electrical connector 418a of the second portion 408 to complete an electrical circuit from the electronic component 416 to the first portion 406. One or more circuitry elements, including wires and other electronic connection components can be disposed within the second portion 406, either on or in the housing 410 or within the internal volume 412, to electrically connect the electronic component 416 with the electrical connector 418a.

In at least one example, they first portion 406 can at least partially extend into the open cavity 414 of the second portion 408. The second portion 408 can connect to the first portion 406 at a proximal end of the second portion 408, as shown, and at least a portion of the first portion 406 can extend into the open cavity 414 of the internal volume 412 of the second portion 408. The extent to which the first portion 406 extends into the second portion 408 can vary in one or more other examples. The outer perimeter dimension of the part of the first portion 406 extending into the open cavity 414 of the second portion 408 is equal to or less than an inner perimeter dimension of the housing 410 of the second portion 408 defining the open cavity 414 of the internal volume 412.

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4.

FIG. 5 illustrates an example of a head-mountable electronic device 500, such as a virtual reality or augmented reality optical device. The device 500 can include a viewing frame 502 and a securement arm 504 extending from the viewing frame 502. In at least one example, the securement arm 504 can include a first portion 506 and a second portion 508 removably connected to the first portion 506. In the illustrated example, the second portion 508 is positioned generally distally to the first portion 506. The second portion can include a housing 510 defining an internal volume 512 that has an open cavity 514. The second portion 508 can also include an electronic component 516 disposed distally to the open cavity 514 in the internal volume 512, as shown.

The first portion 506 can include an electrical connector 518b that contacts an electrical connector 518a of the second portion 508 to complete an electrical circuit from the electronic component 516 to the first portion 506. One or more circuitry elements 522, including wires and other electronic connection components can be disposed within the second portion 506, either on or in the housing 510 or within the internal volume 512, to electrically connect the electronic component 516 with the electrical connector 518a.

In at least one example, they first portion 506 can at least partially extend into the open cavity 514 of the second portion 508. The second portion 508 can connect to the first portion 506 at a proximal end of the second portion 508, as shown, and at least a portion of the first portion 506 can extend into the open cavity 514 of the internal volume 512 of the second portion 508. In at least one example, the second portion 508 can including a latching mechanism that removably secures the second portion 508 to the first portion 506. In at least one example, the first portion 506 can include the latching mechanism or the latching mechanism can be included on both the first and second portions 506, 508. For example, as shown in FIG. 5, one example of a latching mechanism can include a detent mechanism, including a protrusion 524 of the second portion 508 inserted into and held together by friction with a complimentary channel 526 of the first portion 506. Other latching mechanisms, including magnetic mechanisms, button mechanisms, and so forth can also be included.

The extent to which the first portion 506 extends into the second portion 508 can vary in one or more other examples. The outer perimeter dimension of the part of the first portion 506 extending into the open cavity 514 of the second portion 508 is equal to or less than an inner perimeter dimension of the housing 510 of the second portion 508 defining the open cavity 514 of the internal volume 512.

In at least one example, as shown in FIG. 5, the smaller dimension of the first portion 506 and the larger dimension of the second portion 508 noted above can form a gap 507 between the first portion 506 disposed within the open cavity 514 of the second portion 508. In this way, the first portion can be free-floating in the open cavity 514. The term “free-floating,” and other similar terms used herein, can refer to a state of being uncontacted by surrounding components and surfaces. Some portions, lengths, or parts of the first portion 506 can be in contact with or connected to the second portion 508, as shown at the proximal end of the second portion 508 in FIG. 5, while another portion, length, or part of the first portion 506 can be free-floating within the open cavity 514 of the second portion 508, as shown.

In addition, in at least one example, the second portion 508 of a securement arm for a head-mountable display, such as a head-mountable optical device 500, can disposed at an angle relative to the first portion 506. In some examples, a distal end or segment 528 of the second portion 508 can be curved, as shown in FIG. 5, to extend distally and downward behind a user's ear during use.

Any of the features, components, and/or parts, including the arrangements and configurations thereof shown in FIG. 5 can be included, cither alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5.

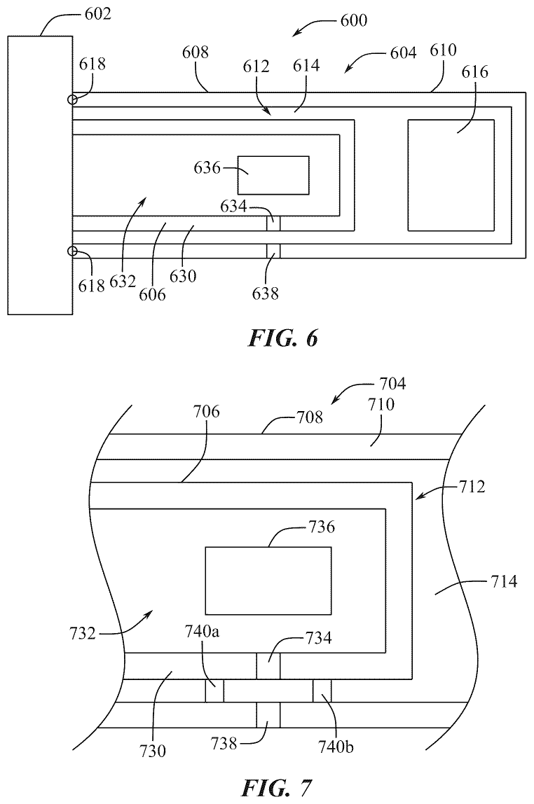

FIG. 6 illustrates an example of a head-mountable electronic device 600, such as a virtual reality or augmented reality optical device. The device 600 can include a viewing frame 602 and a securement arm 604 extending from the viewing frame 602. In at least one example, the securement arm 604 can include a first portion 606 and a second portion 608 removably connected to the first portion 606. In the illustrated example, the second portion 608 is positioned generally distally to the first portion 606. The second portion can include a housing 610 defining an internal volume 612 that has an open cavity 614. The second portion 608 can also include an electronic component 616 disposed distally to the open cavity 614 in the internal volume 612, as shown.

The first portion 606 and the second portion can include electrical connectors, as shown in other figures, which contact each other at 618 shown in FIG. 6. The electrical connector 618 can complete an electrical circuit from the electronic component 616 to the first portion 606. One or more circuitry elements, including wires and other electronic connection components can be disposed within the second portion 606, either on or in the housing 610 or within the internal volume 612, to electrically connect the electronic component 616 with the electrical connector 618.

In at least one example, they first portion 606 can at least partially extend into the open cavity 614 of the second portion 608. The second portion 608 can connect to the first portion 606 at a proximal end of the second portion 608, as shown, and at least a portion of the first portion 606 can extend into the open cavity 614 of the internal volume 612 of the second portion 608. The extent to which the first portion 606 extends into the second portion 608 can vary in one or more other examples. The outer perimeter dimension of the part of the first portion 606 extending into the open cavity 614 of the second portion 608 is equal to or less than an inner perimeter dimension of the housing 610 of the second portion 608 defining the open cavity 614 of the internal volume 612.

In addition, in at least one example, the first portion 606 can include a housing 630 defining an internal volume 632 and an electronic component 636 disposed within the internal volume 632. The electronic component 636 can be connected to the electronic component 616 of the second portion 608 through various circuitry components and electronic connections 618 discussed elsewhere herein. In at least on example, the electronic component 636 disposed in the first portion 606 can include a speaker and the circuitry components can include wires and circuit boards, or any other electronic components used in the head-mountable device to deliver augmented or virtual reality visuals, sounds, and other outputs. The housing 632 of the first portion 606 can define a first aperture 634 and the speaker 636 can be disposed, oriented, or otherwise configured to direct an output, such as sound waves and vibrations, through the first aperture 634. The electronic component 636, or speaker 636, can be positioned to fluidly communicate with an external environment through the first aperture 634.

In addition, in at least one example, the housing 610 of the second portion 608 can define a second aperture 638 through which the output of the speaker 636 can be directed through the housing 610 of the second portion 608. The second aperture 638 can be disposed distally to the proximal opening or end of the second portion 608. In at least one example, as shown in FIG. 6, the first and second apertures 634, 638 can be aligned, as shown in FIG. 6. However, other examples of securement arms can include first and second apertures 634, 638 are misaligned such that one or the other is positioned more proximally or more distally than the other relative to the viewing frame 602. The quality of the output of the electronic device 636 disposed within the first portion 606, for example the quality of sound output from a speaker, from the user's perspective, can be based, at least in part, on the position of the second aperture 638, through which sound exits the securement arm 604.

This may be the case, for example, if a user having an car position different than another user connects a second portion 608 of the securement arm 604 with an aperture positioned for his or her car, which may be different than the position of another user's ear. The position of the second aperture 638 can be customized or chosen based on the position of a specific user's ear relative to their nose such that a second portion 608 having a position of the second aperture 638 relative to the viewing frame 602, which rests on the user's nose, is optimal for that user. Before using or purchasing a device, a user can determine the critical anatomical measurements and purchase or use a swappable, removable second portion 608 based on those measurements.

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6.

FIG. 7 shows a partial, cross-sectional view of another example of a securement arm 704, including a first portion 706 disposed within an open cavity 714 of an internal volume 712 defined by a housing 710 of a second portion 708. The first portion 706 can include a housing 730 defining an internal volume 732 in which a speaker 736 or other electronic component is disposed. The housing 730 of the first portion 706 can define a first aperture 734 and the housing 710 of the second portion 708 can define a second aperture 738, through which the speaker 736 can direct a sound output. In examples where a gap is formed between the housing 730 of the first portion 706 and the housing 710 of the second portion 708, as shown in FIG. 7, one or more output barriers 740a, 740b can be disposed between the housing 710 of the second portion 708 and the housing 730 of the first portion 706. The output barriers 740a, 740b can closed off an output path between the first and second apertures 734, 738 to prevent or minimize sound traveling elsewhere within the inner volume 712 of the second portion 708 after passing through the first aperture 734.

Any of the features, components, and/or parts, including the arrangements and configurations thereof shown in FIG. 7 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7.

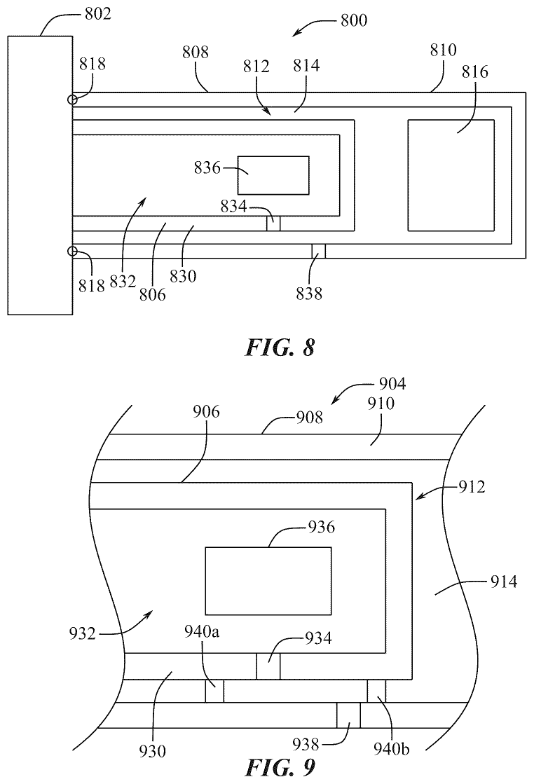

FIG. 8 illustrates an example of a head-mountable electronic device 800, such as a virtual reality or augmented reality optical device. The device 800 can include a viewing frame 802 and a securement arm 804 extending from the viewing frame 802. In at least one example, the securement arm 804 can include a first portion 806 and a second portion 808 removably connected to the first portion 806. In the illustrated example, the second portion 808 is positioned generally distally to the first portion 806. The second portion can include a housing 810 defining an internal volume 812 that has an open cavity 814. The second portion 808 can also include an electronic component 816 disposed distally to the open cavity 814 in the internal volume 812, as shown.

The first portion 806 and the second portion can include electrical connectors, as shown in other figures, which contact each other at 818 shown in FIG. 8. The electrical connector 818 can complete an electrical circuit from the electronic component 816 to the first portion 806. One or more circuitry elements, including wires and other electronic connection components can be disposed within the second portion 806, either on or in the housing 810 or within the internal volume 812, to electrically connect the electronic component 816 with the electrical connector 818.

In at least one example, they first portion 806 can at least partially extend into the open cavity 814 of the second portion 808. The second portion 808 can connect to the first portion 806 at a proximal end of the second portion 808, as shown, and at least a portion of the first portion 806 can extend into the open cavity 814 of the internal volume 812 of the second portion 808. The extent to which the first portion 806 extends into the second portion 808 can vary in one or more other examples. The outer perimeter dimension of the part of the first portion 806 extending into the open cavity 814 of the second portion 808 is equal to or less than an inner perimeter dimension of the housing 810 of the second portion 808 defining the open cavity 814 of the internal volume 812.

In addition, in at least one example, the first portion 806 can include a housing 830 defining an internal volume 832 and an electronic component 836 disposed within the internal volume 832. The electronic component 836 can be connected to the electronic component 816 of the second portion 808 through various circuitry components and electronic connections 818 discussed elsewhere herein. In at least on example, the electronic component 836 disposed in the first portion 806 can include a speaker. The housing 832 of the first portion 806 can define a first aperture 834 and the speaker 836 can be disposed, oriented, or otherwise configured to direct an output, such as sound waves and vibrations, through the first aperture 834.

In addition, in at least one example, the housing 810 of the second portion 808 can define a second aperture 838 through which the output of the speaker 836 can be directed through the housing 810 of the second portion 808. The second aperture 838 can be disposed distally to the proximal opening or end of the second portion 808. In at least one example, as shown in FIG. 8, the first and second apertures 834, 838 can be aligned, as shown in FIG. 8. In the example shown in FIG. 8, the second aperture 838 is disposed distally to the first aperture 834. This position of the second aperture 838 can accommodate a user's specific ear position to optimize the location of sound output by the speaker 836 and through the first and second apertures 834, 838 of the securement arm 804.

Any of the features, components, and/or parts, including the arrangements and configurations thereof shown in FIG. 8 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8.

FIG. 9 shows a partial, cross-sectional view of another example of a securement arm 904, including a first portion 906 disposed within an open cavity 914 of an internal volume 912 defined by a housing 910 of a second portion 908. The first portion 906 can include a housing 930 defining an internal volume 932 in which a speaker 936 or other electronic component is disposed. The housing 930 of the first portion 906 can define a first aperture 934 and the housing 910 of the second portion 908 can define a second aperture 938, through which the speaker 936 can direct a sound output. In examples where a gap is formed between the housing 930 of the first portion 906 and the housing 910 of the second portion 908, as shown in FIG. 9, one or more output barriers 940a, 940b can be disposed between the housing 910 of the second portion 908 and the housing 930 of the first portion 906. The output barriers 940a, 940b can closed off an output path between the first and second apertures 934, 938 to prevent or minimize sound traveling elsewhere within the inner volume 912 of the second portion 908 after passing through the first aperture 934.

Any of the features, components, and/or parts, including the arrangements and configurations thereof shown in FIG. 9 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 9.

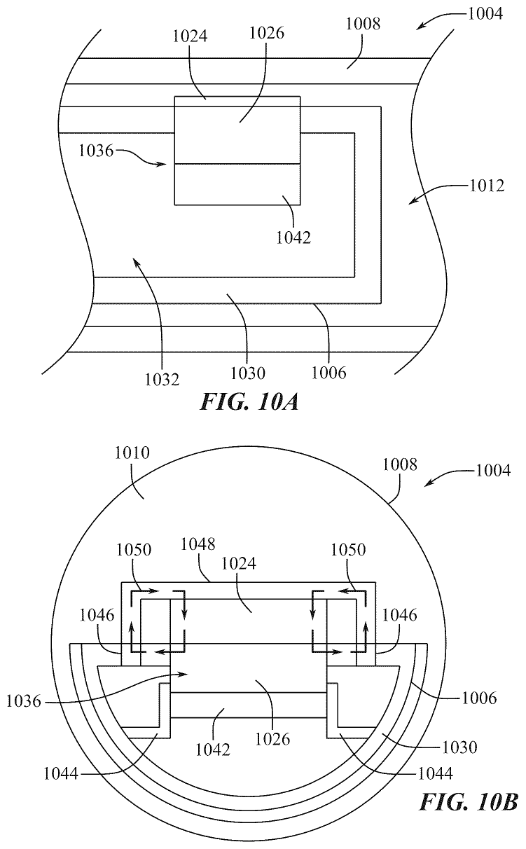

FIGS. 10A and 10B show a partial, cross-sectional view and a cross-sectional view, respectively of another example a securement arm 1004, including a first portion 1006 disposed within an internal volume 1012 defined by a housing 1010 of a second portion 1008. The first portion 1006 can include a housing 1030 defining an internal volume 1032 with an electronic component 1036 disposed within the internal volume 1032. In at least one example, the electronic component 1036 can include a speaker that includes a speaker diaphragm 1042 and a speaker magnet 1026 configured to actuate the diaphragm 1042.

In addition, in at least one example, the removable second portion 1008 of the securement arm 1004 can include a latching mechanism 1024 that is disposed next to, adjacent with, or aligned by the speaker magnet 1026 of the speaker 1036. In one example, the latching mechanism 1024 can include a latching magnet 1024. The latching magnet 1024 can be disposed on or in the housing 1010 or internal volume 1012 of the second portion 1008 such that an attraction between the latching magnet 1024 and the speaker magnet 1026 maintains the second portion 1008 in position relative to the first portion 1006. The attractive force between the two magnets 1024, 1026 can be overcome by the user to separate the first and second portion 1006, 1008 of the removable securement arm 1004 when disconnecting the second portion 1008 from the first portion 1006.

In addition, in at least one example, the latching magnet 1024 can combine with the speaker magnet 1026 to actuate the speaker diaphragm 1042 along with the speaker magnet 1026. In the cross-sectional view of FIG. 10B, another example is shown of the latching magnet 1024 aligned with, above, or next to the speaker magnet 1026 actuating the speaker diaphragm 1042. In the illustrated example, the speaker 1036 can be held in place within the first portion 1006 via a bracket 1044 and one or more conductive members, including a first conductive member 1046 of the first portion 1006 and a second conductive member 1048 of the second portion 1008, can be disposed and configured to direct a magnetic field 1050, illustrated by directional field arrows, such that the magnetic field 1050 flows through the combined speaker magnet 1026 and latching magnet 1024 to actuate the speaker diaphragm 1024. In this way, the latching magnet can serve a dual purposed of removably connecting the second portion 1008 to the first portion 1006 of the securement arm 1004 and actuating the speaker 1036 in the first portion 1006. As a result, the size of the speaker magnet 1026 disposed in the first portion 1006 can be reduced while maintaining speaker performance with the combine magnet configuration shown.

Any of the features, components, and/or parts, including the arrangements and configurations thereof shown in FIGS. 10A and 10B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 10A and 10B.

Physical environments include tangible elements that can be interacted with without the use of electronic devices. For instance, a physical environment may correspond to a physical city having physical buildings, roads, and vehicles. People may directly sense or interact with a physical environment through any number of senses such as smell, sight, taste, hearing, and touch. In contrast, an extended reality (XR) environment may refer to a partially or wholly simulated environment that people may sense or interact with using an electronic device. The XR environment may include virtual reality (VR) content, mixed reality (MR) content, augmented reality (AR) content, or the like. Using an XR system, a portion of a person's physical motions, or representations thereof, may be tracked and, in response, properties of virtual objects in the XR environment may be changed in a way that complies with at least one law of nature. For example, the XR system may detect a user's head movement and adjust auditory and graphical content presented to the user in a way that simulates how sounds and views would change in a physical environment. In other examples, the XR system may detect movement of an electronic device (e.g., a laptop, tablet, mobile phone, or the like) presenting the XR environment. Accordingly, the XR system may adjust auditory and graphical content presented to the user in a way that simulates how sounds and views would change in a physical environment. In some instances, other inputs, such as a representation of physical motion (e.g., a voice command), may cause the XR system to adjust properties of graphical content.

Numerous types of electronic systems may allow a user to sense or interact with an XR environment. A non-exhaustive list of examples includes lenses having integrated display capability to be placed on a user's eyes (e.g., contact lenses), heads-up displays (HUDs), projection-based systems, head mountable systems, windows or windshields having integrated display technology, headphones/earphones, input systems with or without haptic feedback (e.g., handheld or wearable controllers), smartphones, tablets, desktop/laptop computers, and speaker arrays. Head mountable systems may include an opaque display and one or more speakers. Other head mountable systems may be configured to receive an opaque external display, such as that of a smartphone. Head mountable systems may capture images/video of the physical environment using one or more image sensors or capture audio of the physical environment using one or more microphones. Instead of an opaque display, some head mountable systems may include a transparent or translucent display. Transparent or translucent displays may direct light representative of images to a user's eyes through a medium, such as a hologram medium, optical waveguide, an optical combiner, optical reflector, other similar technologies, or combinations thereof. Various display technologies, such as liquid crystal on silicon, LEDs, uLEDs, OLEDs, laser scanning light source, digital light projection, or combinations thereof, may be used. In some examples, the transparent or translucent display may be selectively controlled to become opaque. Projection-based systems may utilize retinal projection technology that projects images onto a user's retina or may project virtual content into the physical environment, such as onto a physical surface or as a hologram.

Personal information data, collected according to authorized and well established secure privacy policies and practices that are appropriate for the type of data collected, can be used to implement and improve on the various concepts described herein. The disclosed technology is not, however, rendered inoperable in the absence of such personal information data.

It will be understood that the details of the present systems and methods above can be utilized in various combinations and with alternative components. The scope of the present systems and methods will be further understood by the following claims.

What is claimed is:

1. A removable securement arm of an optical device, comprising:
a housing defining an internal volume including an open proximal cavity;
an electronic component disposed in the internal volume adjacent to the open proximal cavity; and
an electrical connector disposed on the housing.

2. The removable securement arm of claim 1, wherein the electronic component comprises a battery.

3. The removable securement arm of claim 1, wherein the electronic component is disposed in a distal portion defined by the housing.

4. The removable securement arm of claim 1, wherein the electrical connector is disposed at a proximal end of the housing.

5. The removable securement arm of claim 1, further comprising a circuitry component connecting the electrical connector to the electronic component.

6. The removable securement arm of claim 1, wherein a proximal end of the removable securement arm defines an opening.

7. The removable securement arm of claim 6, wherein the housing defines an aperture distal to the opening.

8. A securement arm of an optical device, comprising:
a first portion including:
a first housing defining a first internal volume and a first aperture; and
an electronic component disposed in the internal volume and positioned to fluidly communicate with an external environment through the first aperture; and
a second portion removably connected to the first portion, the second portion comprising:
a second housing defining a second internal volume and a second aperture; and
a securement mechanism;
wherein the second housing is sized to receive the first housing into the second internal volume.

9. The securement arm of claim 8, wherein the securement mechanism comprises a magnet.

10. The securement arm of claim 9, wherein the electronic component comprises a speaker.

11. The securement arm of claim 10, wherein the magnet actuates the speaker.

12. The securement arm of claim 10, wherein the speaker directs sound out of the second aperture.

13. The securement arm of claim 8, wherein a gap is formed between an external surface of the first housing and an internal surface of the second housing when the second housing receives the first housing.

14. A head mountable display, comprising:
a viewing frame;
a first arm portion extending from the viewing frame, the first arm portion having a first housing extending from a proximal end to a distal end; and
a second arm portion removably secured to the first arm portion, the second arm portion comprising a second housing defining a second internal volume including an open cavity;
wherein the second arm portion contacts the first arm portion at the proximal end and the first housing is free-floating in the open cavity.

15. The head-mountable display of claim 14, wherein the first housing defines a first internal volume and a first electronic component is disposed in the first internal volume.

16. The head-mountable display of claim 15, further comprising a second electronic component disposed in the second internal volume.

17. The head-mountable display of claim 17, wherein the second electronic component comprises a battery.

18. The head-mountable display of claim 15, wherein the first electronic component comprises a speaker.

19. The head-mountable display of claim 18, wherein the second arm portion comprises a magnet.

20. The head-mountable display of claim 19, wherein the magnet actuates the speaker.
